(19) United States
(12) Patent Application Publication
(10) Pub. No.: US 2005/0100351 A1
(43) Pub. Date: May 12, 2005

(54) Quantum communication system and a receiver for a quantum communication system

(75) Inventors: Zhiliang Yuan, Cambridge (GB); Andrew James Shields, Cambridge (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/920,433

(22) Filed: Aug. 18, 2004

(30) Foreign Application Priority Data
Aug. 18, 2003 (GB) 0319370.3

(51) Int. Cl. H04B 10/06

(52) U.S. Cl. 398/214

(57) ABSTRACT

A receiver for receiving encoded photons in a quantum communication system, the receiver comprising a decoder for decoding received encoded photons and a detector for detecting photons outputted from said decoder, the receiver further comprising a band pass filter configured such that said encoded photons pass through the filter before entering the detector

The present invention is concerned with the field of quantum communication systems and receivers which may be used in such systems Specifically, the present invention is concerned with systems which have a very low bit error rate even over long distances.

In quantum communication systems, information is transmitted between a sender and a receiver by encoded single quanta, such as single photons. Each photon carries one bit of information encoded upon a property of the photon, such as its polarisation, phase or energy/time. The photon may even carry more than one bit of information, for example, by using properties such as angular momentum.

Quantum key distribution which is a technique for forming a shared cryptographic key between two parties; a sender, open referred to as “Alice”, and a receiver often referred to as “Bob”. The attraction of this technique is that it provides a test of whether any part of the key can be known to an unauthorised eavesdropper (Eve). In many forms of quantum key distribution, Alice and Bob use two or more non-orthogonal bases in which to encode the bit values. The laws of quantum mechanics dictate that measurement of the photons by Eve without prior knowledge of the encoding basis of each causes an unavoidable change to the state of some of the photons. These changes to the states of the photons will cause errors in the bit values shared by Alice and Bob. By comparing a part of their common bit sting, Alice and Bob can thus determine if Eve has gained information.

Examples of quantum communication systems are described in GB 2 368 502 from the current applicant.

Although there have been successful bench-scale trials of quantum communication systems, to develop a commercially useful system, it is necessary in many situations to distribute a quantum key over distances of at least 100 km.

It has been found that transmission over a long length of cable increases the error rate in a distributed key to an unmanageable level. The present invention addresses the above problem using two routes, the first compensates for signal degradation in long cables, the second substantially decreases the error rate introduced by the receiver itself regardless of the length of cable.

Thus, in a first aspect, the present invention provides a receiver for receiving encoded photons in a quantum communication system, the receiver comprising a decoder for decoding received encoded photons and a signal detector for detecting photons outputted from said decoder, the receiver further comprising a band pass filter configured such that said encoded photons pass through the filter before entering said detector.

The band pass filter may be provided at any point in the receiver before the signal detector, providing that the encoded photons pass through the filter before reaching the detector. For example, it may be provided before the decoder or between the decoder and signal detector. Two or more band pass filters may be used. For example, one filter may be provided before the decoder, the other after the decoder.

Some receivers will comprise two or more signal detectors, for example, the decoder will have two outputs and a signal detector will be provided on each output. A filter may be provided between the decoder and each signal detector.

Generally, the photons which carry the bit values are referred to as the “signal pulse” or ‘encoded photons’. For the avoidance of doubt, the phrase ‘encoded photons’ refers to all photons which have passed through an encoder regardless of whether or not an encoding signal was applied to the photons and whether or not the photons have passed through a decoder. Photons which have passed through the decoder will generally still carry bit values.

Photons from other sources, for example, a clock or reference source, may be transmitted to the receiver along the same route as the encoded photons which carry the bit values.

Often these other sources will be more intense that the source for the encoded photons. Typically, a coupler or other type of beam splitter is provided to separate out photons from the other sources, e.g. the clock or reference source, and to prevent them from entering the decoder or signal detector of the receiver.

Surprisingly, the inventors have found that the erroneous detection events in the signal detector increase as the cable length increases. It is believed that the problem arises because of the interaction of the intense pulse of the clock, reference or other signal with the fibre. The interaction process generates unwanted photons at other (e.g. longer) wavelengths than the intense pulse. This may be due to luminescence or inelastic scattering processes during propagation of the intense pulse along the fibre. Although these processes are weak, they can produce a photon flux close to the wavelength of the encoded photons that is comparable to that of the encoded photons. The problem may be exasperated by the fact that if the wavelength of the encoded photons is close to a fibre transmission window, e.g. 1.55 μm, the unwanted photons induced by the intense pulse can survive long fibre lengths due minimal transmission loss. These unwanted photons contribute to the error rate and therefore inhibit eavesdropper detection, especially for long fibre lengths for which the rate of encoded photons is low.

Usually the intense pulse may be sent along the fibre at a different time in the clock cycle to the encoded photon pulse. Usually this helps to suppress erroneous counts due to the clock laser, as the signal detector can be gated ‘on’ only during a short detection window around the arrival time of the encoded photon pulse. However, because the unwanted photons are at a different wavelength to the intense pulse, they have a different propagation speed along the fibre. Their time of arrival depends upon the position at which they are generated in the fibre, resulting in a large spread in time for the unwanted photons. It is therefore difficult to separate the unwanted photons from the encoded photons by time gating of the signal detector.

In order to address this problem and decrease the bit error rate, the inventors provide a band pass filter before the signal detector to block all photons except for the encoded photons from entering the signal detector. The bandpass filter may be placed in the path of the signal photons before they enter the signal detector, or alternatively, before they enter the decoder.

As previously mentioned, typically, the other photons sent along the fibre will be photons from a clock or reference signal. The band pass filter is configured to pass photons from the signal source or the source for encoded photons and is also configured to ensure that it blocks most photons created by interaction of the clock or reference source and fibre.

When a clock signal is received by the receiver in addition to the encoded photon pulse, a divider is provided to direct encoded photon pulse towards the decoder and the clock signal towards the clock recovery unit. The band pass filter is provided in the path of the encoded photons after this divider.

Typically, the band pass filter has a filter width of at most 5 nm, more preferably at most 1 nm. Most preferably the bandpass of the filter will be substantially equal to, or slightly larger than, the spectral width of the encoded photons arriving at the receiver. The band pass filter is configured to ensure that it has as large a transmission as possible at the band pass wavelength. Preferably, it will be integrated with connecting optical fibres. The filter may consist of a stack of dielectric thin films designed to have a transmission maximum at the wavelength of the encoded photons.

In quantum communication systems, it is necessary to control the polarisation of the photons. This is because in systems which use phase or time-based encoding, only light pulses with the same polarisation can undergo interference. To improve the visibility of the interference, polarisation maintaining components are used so that each pulse in the system has a well defined polarisation state. However, imperfections and misalignments of these components allow a small component of the orthogonal polarisation into each pulse. The interference fringes of the orthogonal component have a different phase from the main component and therefore degrade the visibility of the interferometer.

Thus, preferably, a polarising element is provided in the path of the encoded photons, said element being configured to pass only photons of a predetermined polarisation to said detector. Most preferably the polarising element is provided between the decoder and signal detector.

Although, the above polarising element may be used in combination with the narrow band pass filter, it may also be used in a system on its own.

Thus, in a second aspect the present invention provides a receiver for receiving encoded photons in a quantum communication system, the receiver comprising a decoder for decoding received encoded photons and a detector for detecting photons outputted from said decoder, the receiver further comprising a polarising element, said element being configured to pass only photons of a predetermined polarisation to said detector.

Preferably, the polarising element is provided between the decoder and the signal detector.

The polarising element is preferably integrated with optical fibres within the receiver. The polarising element may be a polarising sheet or a polarising beam spliter. The polarising element increased the interference visibility to nearly perfect (99.9%). This is compared with 94 to 96% without the filter.

There are a number of different decoders which may be used, for example, polarisation, energy/time and phase. Preferably, a phase decoder is used where the decoder comprises a decoding interferometer, said decoding interferometer comprises an entrance member connected to a long arm and a short arm, said long arm and said short arm being joined at their other ends by an exit member, one of said arms having a phase modulator which allows the phase of a photon passing through that arm to be set to one of at least two values.

Typically, the phase modulators will be provided in the short arms. However, the phase modulators may also be provided in the long arms of both interferometers. Only photons which have passed through the long arm of one interferometer and the short arm of the other are of use in communicating the key. In the four-state protocol, which is sometimes referred to as BB84, Alice modulates her phase modulator to one of four different values, corresponding to phase shifts of 0°, 90°, 180° and 270°. Phase 0° and 180° are associated with bits 0 and 1 in a first encoding basis, while 90° and 270° are associated with bits 0 and 1 in a second encoding basis. The second encoding basis is chosen to be non-orthogonal to the first.

Information may alternatively be sent using the B92 protocol where Alice applies phase shifts of 0° and 90° on her phase modulator randomly. Alice associates 0° with bit=0 and 90° delay with bit=1. Bob applies 180° or 270° to his phase modulator randomly and associates 180° with bit=1 and 270° with bit=0.

Thus, the decoding interferometer may have two outputs and the detector is connected to one of the outputs. Alternatively, a second detector may be connected to the other of the outputs. Polarising elements are preferably provided before each of the detectors.

The decoders may be active decoders where a component is continually switched in order to allow Bob to measure using different non-orthogonal basis. Alternatively, a passive decoder may be provided. In this case the encoded photons received by the decoder are split into two or more paths by a beamsplitter, a combination of beamsplitters or coupler. Measurements using different non-orthogonal bases are performed on the encoded photons taking the different paths. Each path corresponds to a different measurement basis. Detection in one of the signal detectors is used to record not only the measurements result, but also which measurement basis was used. In this case the bandpass filter may be placed in front of the beamsplitter or combination of beamsplitters. Alternatively a bandpass filter may be used in front of each signal detector. A polarising filter may also provided between the decoder and signal detector for each signal detector.

Although the above systems have been described in relation to phase, the same principles apply to encoding and decoding using any quantum parameter such. as polarisation and energy/time. Examples of such systems are described in GB 2 368 502.

As explained above, the receiver is intended for use in a quantum communication system.

Thus, in a third aspect, the present invention provides a quantum communication system comprising an emitter and a receiver, said emitter comprising an encoder, a photon signal source and a clock source, said photon source outputting photons to said encoder for encoding, the receiver being a receiver in accordance either of the first or second aspects of the invention.

In the third aspect of the invention, the clock source may be omitted, especially when the receiver is a receiver of the second aspect of the present invention. Alternatively, it may be replaced by any other source of radiation which is sent to the receiver, e.g. a reference signal.

As previously mentioned, the narrow band pass filter may be tuneable in order to centre the filter in order to achieve maximum transmission of the encoded photons into the decoder. Alternatively, the photon signal source may be tuneable in order to achieve the same effect.

When the decoder comprises an interferometer, the encoding means also comprises an encoding interferometer, said encoding interferometer comprising an entrance member connected to a long arm and a short arm, said long arm and said short arm being joined at their other ends by an exit member, one of said arms having a phase modulator which allows the phase of a photon passing through that arm to be set to one of at least two values.

The quantum communication system is intended primarily for use with encoded photons having a wavelength of substantially 1.55 μm and a clock source having photons with the wavelength of substantially 1.3 μm.

The system preferably comprises a fibre optic cable of at least 50 km and preferably at least 100 km in order to distribute the key between the two stations.

The above description has concentrated on sending the key from an emitter to a receiver. However, this is not always the case as the photons may be reflected between an emitter and receiver.

In a preferred embodiment, a key is distributed between a first station and a second station. Photons are transmitted from the first station to the second station and reflected back from the second station through the first station.

This technique has the advantage that all interfering photons will pass through the same fibres (although in a different order). Thus, there is no need to carefully balance the system since the length of the interfering paths are inherently equal.

Thus, in a fourth aspect, the present invention provides a quantum communication system comprising a first station and a second station, said first station comprising a receiver in accordance with either of the first or second aspect of the invention and a photon source configured to output a pulse through the decoder of said first station, said second station comprising means to apply an encoding signal to said photons and reflecting means to reflect the pulse back through the decoder of said first station.

Also, a key may be distributed using an entangled photon pair source. In this case, a single source transmits to two receivers. Due to the quantum nature of entangled photons, a measurement of one of the photon pairs in one receiver will affect the quantum state of the other of the same photon pair in the other receiver.

Thus, in a fifth aspect, the present invention provides a quantum communication system comprising an entangled photon emitter and two receivers, each receiver being a receiver according to either of the first or second aspects of the invention, said entangled photon emitter comprising a source which is configured to emit photons which are entangled in phase, polarisation or energy/time.

In a sixth aspect, the present invention provides a method of receiving encoded photons in a quantum communication system, the method comprising:
filtering the encoded photons using a band pass filter configured to pass encoded photons;
passing the encoded photons through a decoder; and
detecting the photons outputted by the decoder.

The filtering step may be performed before or after the photons are passed through a decoder.

In a seventh aspect, the present invention provides a method of receiving encoded photons in a quantum communication system, the method comprising:
passing the encoded photons through a decoder;
passing the encoded photons through a polarisation element; and
detecting the polarisation filtered encoded photons,
wherein said polarisation element is configured to only pass photons of a desired polarisation for detection

Preferably, the encoded photons are passed through the polarising element after they have passed through the decoder.

In an eighth aspect, the present invention provides a method of quantum communication comprising:
producing encoded photons in an emitter;
sending the encoded photons from the emitter to a receiver;
filtering the encoded photons at the receiver using a band pass filter configured to pass encoded photons;
passing the encoded photons through a decoder in the receiver; and
detecting the photons outputted by the decoder.

The filtering step may be performed before or after the photons are passed through a decoder.

In a ninth aspect, the present invention provides a method of quantum communication comprising:
producing encoded photons in an emitter;
sending the encoded photons from the emitter to a receiver;
passing the encoded photons through a decoder at the receiver;
passing the photons through a polarisation element; and
detecting the polarisation filtered encoded photons,
wherein said polarisation element is configured to only pass photons of a desired polarisation for detection.

Preferably, the encoded photons are passed through the polarising element after they have passed through the decoder.

The present invention will now be described with reference to the following non-limiting preferred embodiments in which:

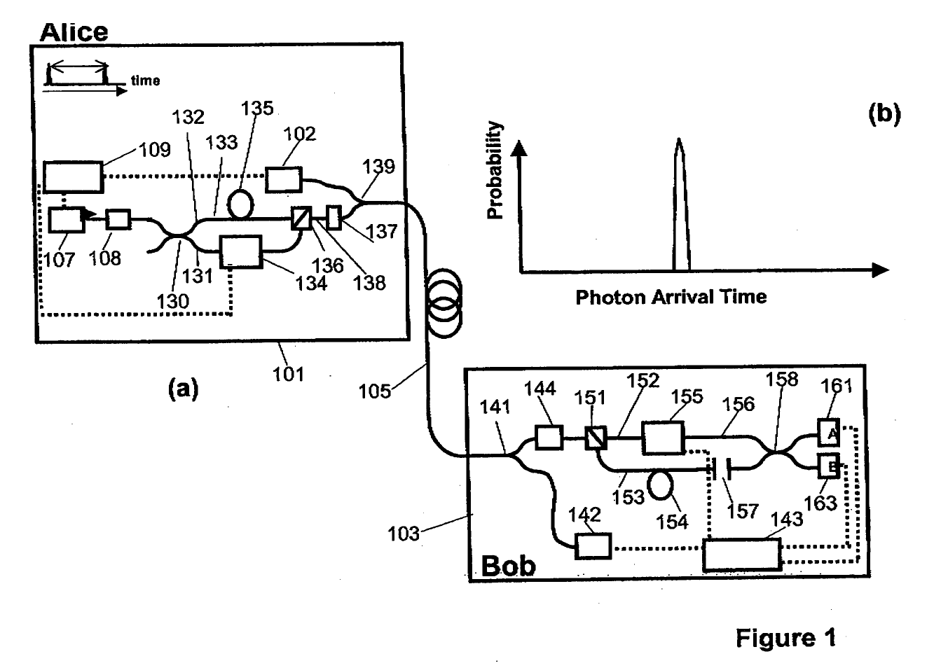

FIG. 1 schematically illustrates a quantum communication system of the prior art;

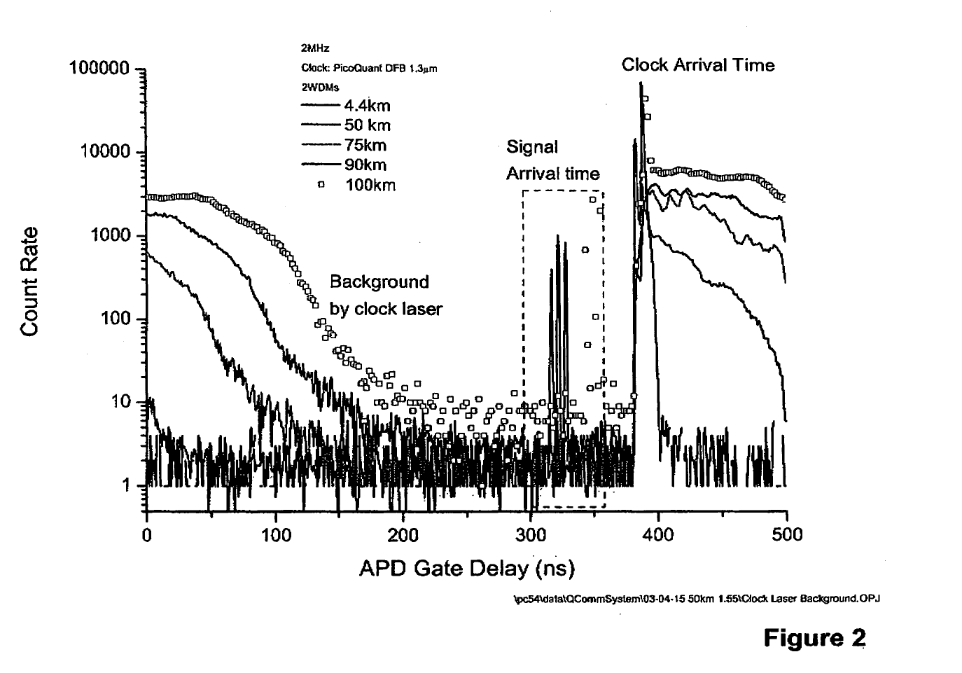

FIG. 2 schematically illustrates a plot of count rate against arrival time at a detector for photons travelling from the emitter to the detector of FIG. 1 along fibres ranging from 4.4 km to 100 km;

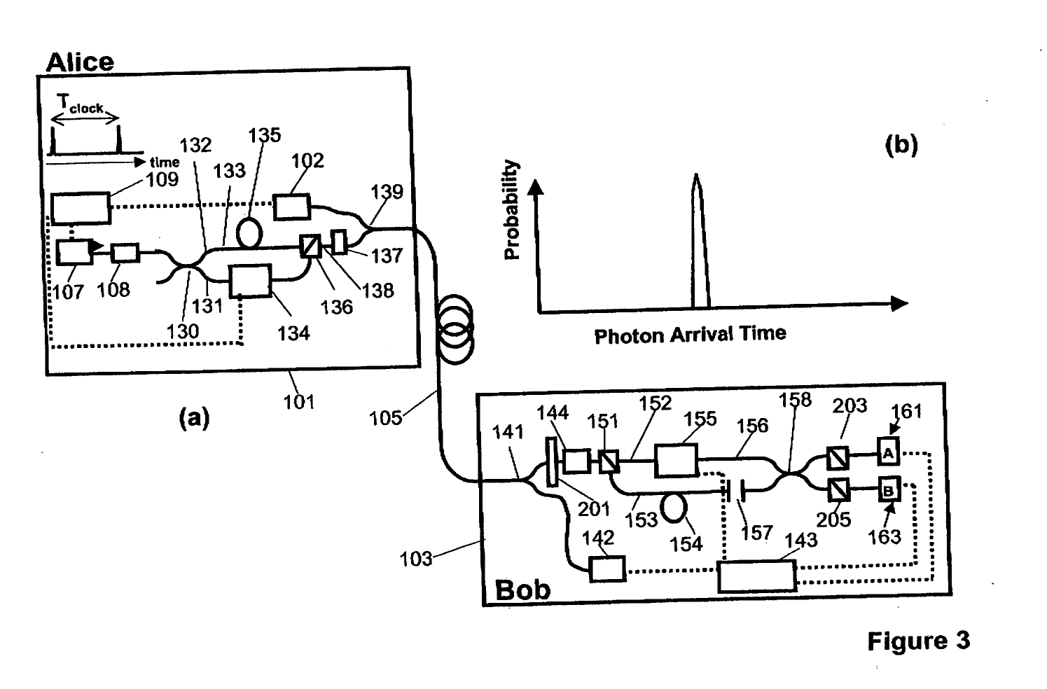

FIG. 3 schematically illustrates a quantum communication system in accordance with an embodiment of the present invention having a narrow band pass filter and a polarising element;

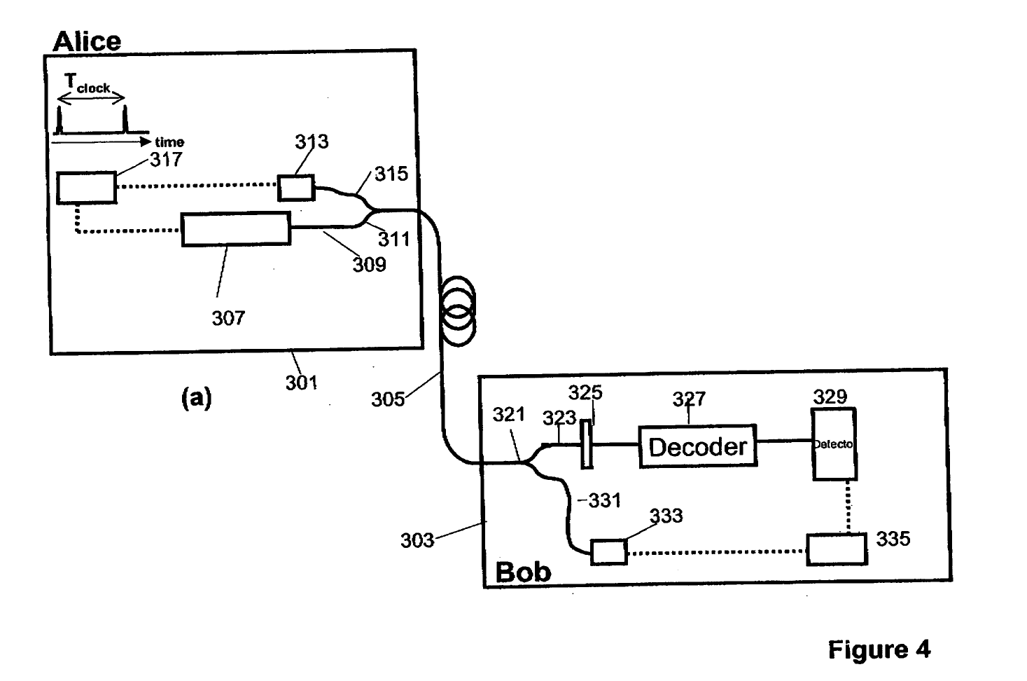

FIG. 4 schematically illustrates a quantum communication system in accordance with a second embodiment of the present invention having a narrow band pass filter;

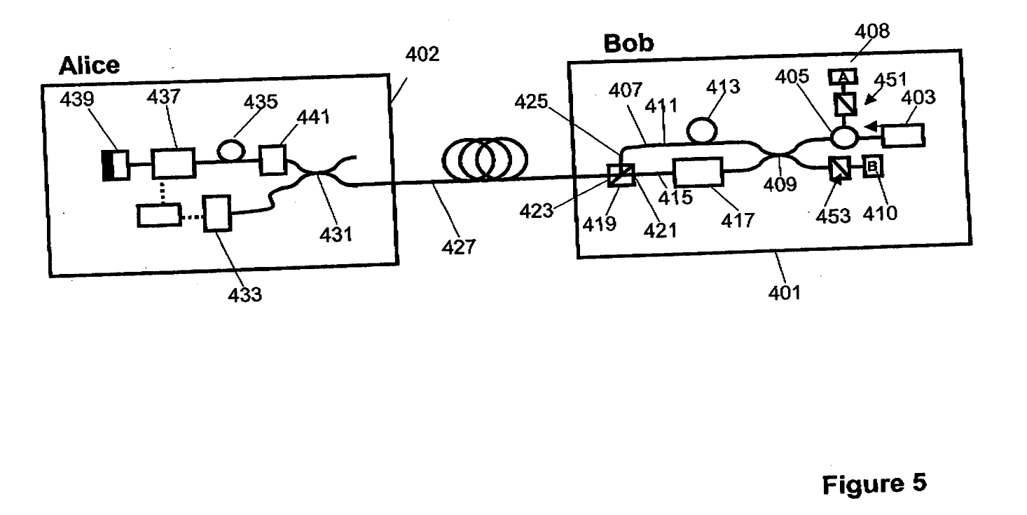

FIG. 5 schematically illustrates a quantum communication system in accordance with a third embodiment of the present invention where the signal pulse is reflected between Alice and Bob; and

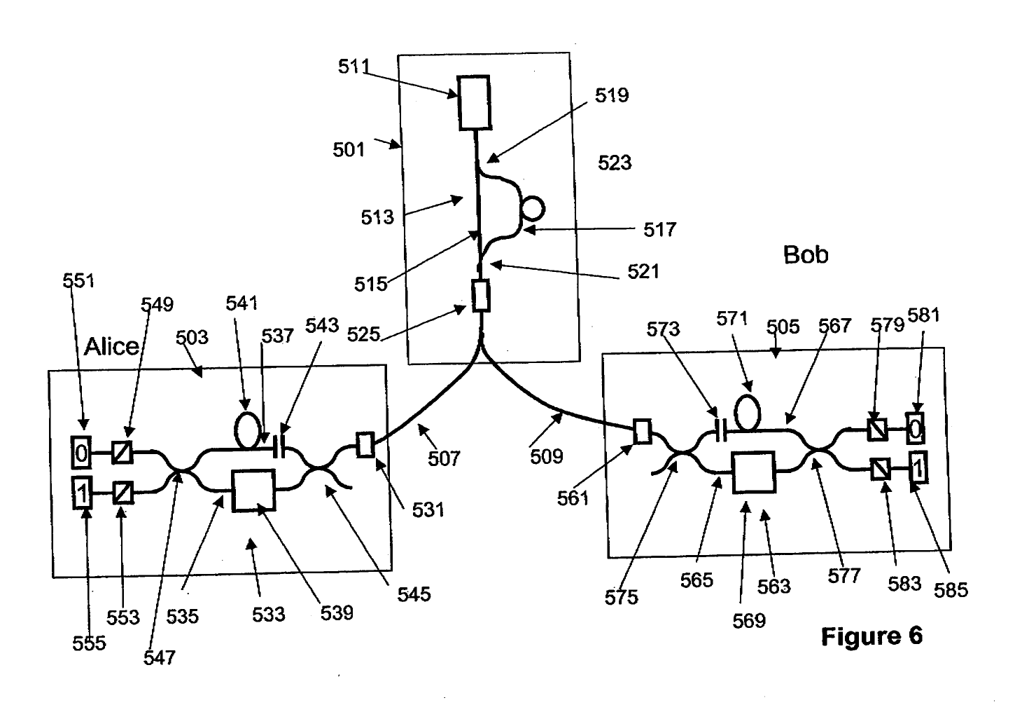

FIG. 6 schematically illustrates a quantum communication system in accordance with a further embodiment of the present invention having an entangled photon pair source.

FIG. 1a shows a prior art quantum cryptography system based upon phase encoding using a polarisation sensitive fibre interferometer.

The sender “Alice” 101 sends encoded photons to receiver “Bob” 103 over optical fibre 105.

Alice's equipment 101 comprises a signal laser diode 107, a polarisation rotator 108 configured to rotate the polarisation of pulses from signal laser diode 107, an imbalanced fibre Mach-Zender interferometer 133 connected to the output of polarisation rotator 108, an attenuator 137 connected to the output of the interferometer 133, a bright clock laser 102, a wavelength division multiplexing (WDM) coupler 139 coupling the output from attenuator 137 and clock laser 102 and bias electronics 109 connected to said signal laser diode 107 and clock laser 102.

The interferometer 133 comprises an entrance coupler 130, one exit arm of entrance coupler 130 is joined to long arm 132, long arm 132 comprises a loop of fibre 135 designed to cause an optical delay, the other exit arm of entrance coupler 130 is joined to a short arm 131, short arm 131 comprises phase modulator 134, an exit polarising beam combiner 136 is connected to the other ends of long arm 132 and short arm 131.

All components used in Alice's interferometer 133 are polarisation maintaining.

During each clock cycle, the signal diode laser 107 outputs one optical pulse. The signal diode laser 107 is connected to biasing electronics 109 which instruct the signal diode laser 107 to output the optical pulse. The biasing electronics are also connected to clock laser 102.

The linear polarisation of the signal pulses outputted by diode laser 107 is rotated by a polarisation rotator 108 so that the polarisation of the pulse is aligned to be parallel to a particular axis of the polarisation maintaining fibre (usually the slow axis) of the entrance coupler 130 of the interferometer 133. Alternatively the polarisation rotator 108 may be omitted by rotating the signal laser diode 107 with respect to the axes of the entrance polarisation maintaining fibre coupler 130.

After passing through the polarisation from rotator (if present) the signal pulses are then fed into the imbalanced Mach-Zender interferometer 133 through a polarisation maintaining fibre coupler 130. Signal pulses are coupled into the same axis (usually the slow axis) of the polarisation maintaining fibre, of both output arms of the polarisation maintaining fibre coupler 130. One output arm of the fibre coupler 130 is connected to the long arm 132 of the interferometer 135 while the other output arm of the coupler 130 is connected to the short arm 131 of the interferometer 133.

The long arm 132 of the interferometer 133 contains an optical fibre delay loop 135, while the short arm 131 contains a fibre optic phase modulator 134. The fibre optic phase modulator 134 is connected to biasing electronics 109 which will be described in more detail later. The length difference of the two arms 131 and 132 corresponds to an optical propagation delay of t_{delay}. Typically the length of the delay loop 135 may be chosen to produce a delay t_{delay}˜5 ns. Thus, a photon travelling through the long arm 132 will lag that travelling through the short arm 131 by a time of t_{delay} at the exit 136 of the interferometer 133.

The two arms 131, 132 are combined together with a polarisation beam combiner 136 into a single mode fibre 138. The fibre inputs of the polarisation beam combiner 136 are aligned in such a way that only photons propagating along particular axes of the polarisation maintaining fibre, are output from the combiner 136. Typically, photons which propagate along the slow axis or the fast axis are output by combiner 136 into fibre 138.

The polarising beam combiner 136 has two input ports, an in-line input port and a 90° input port. One of the input ports is connected to the long arm 132 of the interferometer 133 and the other input port is connected to the short arm 131 of the interferometer 133.

In this example, only photons polarised along the slow axis of the in-line input fibre of the in-line input port are transmitted by the polarising beam combiner 136 and pass into the fibre 138. Photons polarised along the fast axis of the in-line input fibre of the input port are reflected and lost.

Meanwhile, at the 90° input port of the beam coupler 136, only photons polarised along the slow axis of the 90° input fibre are reflected by the beam combiner 136 and pass into the output port, while those polarised along the fast axis will be transmitted out of the beam combiner 136 and lost.

This means that the slow axis of one of the two input fibres is rotated by 90° relative to the output port. Alternatively the polarisation may be rotated using a polarisation rotator (not shown) before one of the input ports of the polarising beam combiner (136).

Thus, photon pulses which passed through the long 132 and short arms 131 will have orthogonal polarisations.

The signal pulses are then strongly attenuated by the attenuator 137 so that the average number of photons per signal pulse μ<<1.

The signal pulses which are outputted by the combiner 136 into single mode fibre 138 are then multiplexed with a bright laser clock source 102 at a different wavelength using a WDM coupler 139. The multiplexed signal is then transmitted to the receiver Bob 103 along an optical fibre link 105. The biasing electronics 109 synchronises the output of the clock source 102 with the signal pulse.

Bob's equipment 103 comprises WDM coupler 141, a clock recovery unit 142 connected to an output of coupler 141, a polarisation controller 144 connected to the other output of WDM coupler 141, an imbalanced Mach-Zender interferometer 156 connected to the output of polarisation controller 144, two single photon detectors A 161, B 163 connected to the output arms of interferometer 156 and biasing electronics 143 connected to the detectors 161, 163. Bob's interferometer 156 contains an entrance polarising beam splitter 151 connected to both; a long arm 153 containing a delay loop 154 and a variable delay line 157; and a short arm 152 containing a phase modulator 155. The long arm 153 and short arm 152 are connected to an exit polarisation maintaining 50/50 fibre coupler 158. All components in Bob's interferometer 156 are polarisation maintaining.

Bob first de-multiplexes the transmitted signal received from Alice 101 via fibre 105 using the WDM coupler 141. The bright clock laser 102 signal is routed to an optical receiver 142 to recover the clock for Bob 103 to synchronise with Alice 101.

The signal pulses which are separated from the clock pulses by WDM coupler 141 are fed into a polarisation controller 144 to restore the original linear polarisation of the signal pulses. This is done so that signal pulses which travelled the short arm 131 in Alice's interferometer 133, will pass the long arm 153 in Bob's interferometer 156. Similarly, signal pulses which travelled through the long arm 132 of Alice's interferometer 133 will travel through the short arm 152 of Bob' interferometer 156.

The signal then passes through Bob's interferometer 156. An entrance polarising beam splitter 151 divides the incident pulses with orthogonal linear polarisations. The two outputs of the entrance polarisation beam splitter 151 are aligned such that the two output polarisations are both coupled into a particular axis, usually the slow axis, of the polarisation maintaining fibre. This ensures that signal pulses taking either arm will have the same polarisation at the exit 50/50 polarisation maintaining coupler 158. The long arm 153 of Bob's interferometer 156 contains an optical fibre delay loop 154 and a variable fibre delay line 157, and the short arm 152 contains a phase modulator 155. The two arms 152, 153 are connected to a 50/50 polarisation maintaining fibre coupler 158 with a single photon detector A 161, B 163 attached to each output arm.

Due to the use of polarising components, there are, in ideal cases, only two routes for a signal pulse travelling from the entrance of Alice's interferometer to the exit of Bob's interferometer:
i. Alice's Long Arm 132—Bob's Short Ann 152 (L-S) and
ii. Alice's Short Arm 131—Bob's Long Arm 153 (S-L).

The variable delay line 157 at Bob's interferometer 156 is adjusted to make the propagation time along routes (i) and (ii) almost equal, within a fraction of the signal laser coherence time which is typically a few picoseconds for a semiconductor distributed feed back (DFB) laser diode, and thereby ensure interference of the two paths.

FIG. 1b is a plot of probability of a photon arriving at either of detectors A 161, B 163 against time.

By controlling the voltages applied to their phase modulators 134, 155, Alice and Bob determine in tandem whether paths (i) and (ii) undergo constructive or destructive interference at detectors A 161 and B 163. The phase modulators 134, 155 are connected to respective biasing means 109 and 143 to ensure synchronisation.

The variable delay line 157 can be set such that there is constructive interference at detector A 161 (and thus destructive interference at detector B 163) for zero phase difference between Alice and Bob's phase modulators. Thus for zero phase difference between Alice's and Bob's modulators and for a perfect interferometer with 100% visibility, there will be a negligible count rate at detector B 163 and a finite count rate at A 161.

If, on the other hand, the phase difference between Alice and Bob's modulators 134, 155 is 180°, there should be destructive interference at detector A 161 (and thus negligible count rate) and constructive at detector B 163. For any other phase difference between their two modulators, there will be a finite probability that. a photon may output at detector A 161 or detector B 163.

In the four-state protocol, which is sometimes referred to as BB84, Alice sets the voltage on her phase modulator to one of four different values, corresponding to phase shifts of 0°, 90°, 180°, and 270°. Phase 0° and 180° are associated with bits 0 and 1 in a first encoding basis, while 90° and 270° are associated with 0 and 1 in a second encoding basis. The second encoding basis is chosen to be non-orthogonal to the first. The phase shift is chosen at random for each signal pulse and Alice records the phase shift applied for each clock cycle.

Meanwhile Bob randomly varies the voltage applied to his phase modulator between two values corresponding to 0° and 90°, This amounts to selecting between the first and second measurement bases, respectively. Bob records the phase shift applied and the measurement result (i.e photon at detector A 161, photon at detector B 163, photon at detector A 161 and detector B 163, or no photon detected) for each clock cycle.

In the BB84 protocol, Alice and Bob can form a shared key by communicating on a classical channel after Bob's measurements have taken place, Bob tells Alice in which clock cycles he measured a photon and which measurement basis be used, but not the result of the measurement. Alice then tells Bob the clock cycles in which she used the same encoding basis and they agree to keep only those results, as in this case Bob will have made deterministic measurements upon the encoded photons. This is followed by error correction, to remove any errors in their shared key, and privacy amplification to exclude any information known to an eavesdropper.

The system in FIG. 1 a is also suitable for implementing the two-state protocol known as B92. In this case only one detector is needed on one output arm of Bob's interferometer 156. The arm lengths are calibrated so that for zero phase delay the photon rate into the detector is maximum (constructive interference).

For the B92 protocol Alice applies phase shifts of 0 and 90° on her phase modulator randomly. Alice associates 0 phase delay with bit=0, and 90° phase delay with bit=1. Bob applies 180° or 270° to his phase modulator randomly, and associates 180° with bit=1 and 270° with bit=0. After Bob's detections, he tells Alice in which clock cycle he detected a photon and they keep these bits to form a shared sifted key. They then perform error correction and privacy amplification upon the sifted key.

FIG. 2 is a plot of count rate along the y-axis against the arrival time at the detector along the x-axis. Five different plots are shown. The upper most plot corresponds to a cable length of 100 km. The cable length refers to the length of cable 105 in FIG. 1. The second highest plot corresponds to a cable length 90 km. The middle plot corresponds to a length of 75 km, and the two plots shown at the bottom of the graph correspond to 50 km and 4.4 km.

In all plots, the signal pulse, which contains a maximum of I encoded photon, arrives at the detector at a time of just over 300 nanoseconds. It will be noted that three individual peaks are seen, this is because there may be some inaccuracies in the polarisation components illustrated in FIG. 1 which will result in some photons passing through the long arms of both interferometers and some photons passing through the short arms of both interferometers.

In the apparatus of FIG. 1, it can be seen that the clock light is divided from the photon signal by wave division multiplexer (WDM) coupler 141. However, it can be seen from the graph of FIG. 2 that as the cable length increases, the background signal increases. The background signal is due to the clock pulse or more correctly, the tail following the clock pulse. At a cable length of 100 km, the tail of the clock pulse extends as far as the photon signal arrival time thus hampering the measurement and inducing errors in the measurement.

FIG. 3 schematically illustrates a quantum communication system which can be used with longer lengths of fibre and still maintain a low error rate. The system is similar to that described with reference to FIG. 1. To avoid unnecessary repetition, like reference numerals will be used to denote like features.

The system of FIG. 3 differs from the system of FIG. 1 in two main ways. First, narrow band pass filter 201 is provided between the WDM coupler 141 and the polarisation controller.

Band pass filter 201 blocks all wavelengths except that of the signal pulses which contain encoded photons . The filter may have a band pass of 5 nm. More preferably, it will have a band pass of 1 nm. The filter 201 is designed to have as large a transmission as possible at the band pass wavelength. Ideally, it will be integrated with the connecting optical fibres.

The filter 201 may consist of a stack of dielectric thin films and designed to have a transition maximum at the signal laser wavelength,

The band pass wavelength is tuneable so that the filter 201 can be tuned to allow maximum transmission of the signal laser. Alternatively, the signal laser which outputs the photons for encoding inay be tuneable and filter 201 is fixed.

In addition to narrow band pass filter 201, polarisation filters 203 and 205 are provided before detectors 161a and 163b.

In the systems shown in FIGS. 1 and 3, information is encoded onto the signal pulse using phase, Only light pulses with the same polarisation can undergo interference. The quantum communication systems described with reference to FIGS. 1 and 3 use polarisation maintaining components. However, there may be imperfections and misalignments of these components which will allow a small component of the orthogonal polarisation into each pulse. To have nearly perfect interference fringes and hence reduce the quantum bit error rate of the system, polarisation filters 203 and 205 are provided before detectors 161a and 163b to remove any erroneous orthogonal components of the polarisation. The polarisation filters 203 and 205 are integrated with connecting optical fibres. The polarisation filters 203 and 205 may be a polarising sheet or a polarising beam splitter.

FIGS. 1 and 3 have described the present invention in relation to phase encoding where both the emitter and receiver comprise an interferometer. It is possible to encode photons using a number of techniques, for example, polarisation encoding, energy/time encoding, etc. Some of these techniques are reviewed in GB 2 368 502. However, all these techniques benefit from the ability to filter out spurious signal created by the interaction between the clock laser and the fibre and the ability to filter out orthogonal polarisation components prior to photon detection.

FIG. 4 is a schematic of a very basic quantum communication system. As in FIGS. 1 and 3, encoded photons are sent from an emitter 301 “Alice” to a receiver 303 “Bob” along a fibre optic 305. In its most basic form, Alice's interferometer comprises a source of encoded photons 307 which are output along optical fibre 309 towards wave division multiplex (WDM) coupler 311. Here, the signal is multiplexed with a clock pulse received from clock laser 313 via fibre 315. The clock pulse from laser 313 is synchronised with the output of the photon source 307 via biasing means 317.

The receiver “Bob” 303 comprises a WDM coupler 321 which receives the output from optical fibre 305. WDM coupler 321 is connected via fibre 323 to narrow band pass filter 325. Narrow band pass filter 325 is configured to only pass the wavelengths of photons arising from photon source 307 in emitter 301. The filtered signal is then passed to decoder 327 which is a decoder suitable for decoding photons which have been encoded by encoder 307.

The output from the decoder 327 is then passed to detector 329 which may be one or more single photon detectors. The WDM coupler 321 is configured to direct clock pulse along fibre 331 to clock recovery circuit 333. Clock recovery circuit 333 outputs a signal to biasing electronics 335 which in turn controls detector 329. The biasing electronics may also control decoder 327 depending on the type of decoding required.

FIG. 5 schematically illustrates a self-compensating apparatus for quantum communication having polarisation filters. In this embodiment, the photons originate from Bob's apparatus 401 and are transmitted to Alice's apparatus 402 along optical fibre link 427.

Bob's equipment 401 comprises a signal laser diode 403, a fibre circulator 405, an imbalanced Mach-Zender polarisation maintaining fibre interferometer 407, two single photon detectors 408, 410 and two polarising filters 451, 453 provided before said single photon detectors 408, 410.

Bob's Mach-Zender interferometer 407 contains a 50/50 polarisation maintaining fibre coupler 409, a long arm 411 with a fibre delay loop 413, a short arm 415 with a phase modulator 417, a polarisation beam splitter 419, and biasing electronics (not shown).

The biasing electronics produce a clock for synchronisation with period T_{clock}, which may typically be 1 μs. The laser diode is biased to emit at least one signal pulse during each clock cycle. For simplicity only one laser pulse will be considered for the remainder of the description of FIG. 5.

The laser 403 is linearly polarised. The laser pulse is coupled into a particular polarisation axis, usually the slow axis, of a polarisation maintaining fibre.

The laser pulse is then fed into the imbalanced interferometer 407 through a circulator 405 and a polarisation maintaining fibre coupler 409. The length difference between the long arm 411 and the short arm 415 of the interferometer corresponds to an optical propagation delay of t_{delay}. A pulse travelling through the long arm 411 (referred to below as the ‘late pulse’) will lag that travelling through the short arm 415 (‘early pulse’) by a time delay at the port 423 of the polarisation beam combiner/splitter 419 of the interferometer 407.

The long arm 411 and the short arm 415 are combined with a polarisation beam splitter 419. The fibre inputs of the polarsation beam combiner 419 are aligned in such a way that only photons propagating along a particular axis of the polarisation maintaining input fibre, usually the slow axis, are output from the combiner. For example, at the in-line input port 421, only photons polarised along the slow axis of the in-line input fibre are transmitted by the beam combiner/splitter 419 and pass into the output port 423 and photons polarised along the fast axis are reflected and lost. Meanwhile, at the 90° input port 425, only photons polarised along the slow axis of the 90° input fibre are reflected by the beam combiner 419 and pass into the output port, while those polarised along the fast axis will be transmitted and lost.

This means that the slow axis of one of the two input fibres is rotated by 90° relative to the output port. Alternatively the polarisation may be rotated using a polarisation rotator before one of the input ports of the polarising beam combiner. Thus photon pulses which passed through the long 411 and short 415 arms will have orthogonal linear polarisations on the output fibre 427.

The pulse is then transmitted to Alice 402 along an optical fibre link 427. No further clock reference need be sent. The pulse is not attenuated before it is sent.

Alice first uses a fibre coupler 431 with an unbalanced coupling ratio, for example 90/10. 90% of the laser pulse forms the clock pulse and is routed into a photodetector 433, to measure the clock pulse intensity and also recover the clock.

The exit from other arm of the fibre coupler, forms the signal pulse and is fed into a storage line 435 after passing an attenuator 441, then a phase modulator 437, and a Faraday mirror 439. The Faraday mirror 439 has the effect of rotating the polarisation of the signal pulse by 90°. The signal pulse reflected by the Faraday mirror passes back through the phase the modulator 437, the storage line 435, the attenuator 441 and the fibre coupler 431 subsequently. The reflected pulse then returns to Bob along the optical fibre link.

Alice applies a voltage to her phase modulator when the early (ie that which passed through the phase modulator 417 in Bob's interferometer) pulse passes back through her phase modulator after reflection at the Faraday mirror.

Before the pulse leaves Alice's coupler, it is attenuated so that the average number of photons per pulse μ<<1. The level of attenuation is chosen according to the signal pulse intensity measured by the Alice's power meter 433.

When the signal pulse returns to Bob's polarisation beam splitter, the polarisations of each early and late pulse have been swapped due to the reflection of the Faraday mirror 439 in Alice's equipment. So, the late pulse will be transmitted by the beamsplitter and propagate alone the Short Ann, while the early pulse will be reflected into the Long Arm. They will then be fed into the polarisation maintaining fibre coupler.

There are two routes for a photon travelling from the Bob's fiber coupler to Alice and then reflected back to the Bob's coupler:
1. Bob's Long Arm—Alice—Bob's Short Arm
2. Bob's Short Arm—Alice—Bob's Long Arm

The total length is exactly identical because a photon passes all the same components but just with different sequences. There is no need to actively balance the length of the two routes, as they are automatically self-compensated. A photon passing two routes interferes with itself at Bob's polarisation maintaining fibre coupler 409.

By controlling the voltages applied to their modulators when the reflected pulse passes through, Alice and Bob determine in tandem whether two routes undergo constructive or destructive interference at each detector. Alice only modulates the reflected early pulse, while Bob modulates the reflected late pulse.

The polarisation maintaining fibre coupler 409 at Bob's interferometer has two output ports. One of the output ports is connected to fibre circulator 405. The fibre circulator 405 is connected to both laser source 403 which has been described above and polarising element 451. Polarising element 451 is connected to single photon detector 408 and is configured to only pass photons of the desired polarisation to said single photon detector. The other output of said coupler 409 is connected to second polarising element 453. Polarising element 453 is connected to single photon detector 410 and is configured to only pass photons of the desired polarisation to said single photon detector 410. This arrangement can be used to implement BB84 or B92 in a similar manner to those described previously.

FIG. 6 schematically illustrates an embodiment of the present invention where an entangled photon source is used. The communication system comprises an entangled photon pair source 501 which sends photons to Alice's receiver 503 and Bob's receiver 505. Photons are sent to Alice's receiver 503 along fibre optic cable 507 and photons are sent to Bob's receiver 505 along fibre optic cable 509.

Entangled photon source 501 comprises a pulsed laser 511 which may be a semiconductor laser diode. It may also be any other type of laser, for example, a gas laser, solid state laser, etc. The light outputted from laser 511 is then directed into a polarization maintaining pump interferometer 513. Pump interferometer 513 comprises a short arm 515 and a long arm 517. The short arm 515 and long am 517 are coupled by an entrance coupler 519 at a first end and an exit coupler or fast switch 521 at the opposing end. The entrance coupler 519 is configured to receive radiation from laser 511.

Both the entrance coupler 519 and the exit coupler 521 are 50/50 fibre couplers.

The long arm 517 has a delay loop 523. The delay loop 523 results in a delay of Tₚᵤₘₚ between photons flowing through the long arm 517 and photons flowing through the short arm 515.

Photons which are passed through interferometer 513 are output from exit coupler 521. The photons have exactly the sane linear polarisation and there is a relative phase delay Φₚ between them.

The split pulses are then passing through the non-linear crystal 525. The polarisation of the input laser pulses and the cut angle and orientation of the non-linear crystal 525 are carefully aligned so that parametric down-conversion processes can happen in the non-linear crystal 525 with down-converted photons of desired wavelengths. The converted photons can have wavelengths at low transmission windows of single mode telecom fibre, for example, 1.3 μm or 1.55 μm.

The non-linear crystal can be, for example, BBO, LBO etc. In parametric down-conversion process, a pump photon of is converted into two photons of lower energies. Energy and momentum are conserved in this process.

Ideally the two photons produced by the down-conversion process have different wavelengths, so that they can be separated into different paths using wavelength-division multiplexing, or a dichromatic mirror.

The down-conversion process can be either be type-I or type-I, In the type-I process, the photon pair have same linear polarisation, while they have orthogonal polarisations in type-II processes.

If type-II process is used, a polarisation beam splitter can be used to separate the photon pair into different paths.

The photon pair generated are entangled in the generation time.

A longpass filter may be inserted before the WDM coupler 525 to prevent the pump laser photons entering the fibre links 507 and 509. It is not absolutely necessary because the fibre links 507 and 509 act naturally as longpass filter due to wavelength dependent fibre loss if they are sufficiently long.

One photon of the entangled photon pair produced by non-linear crystal 525 is directed down optical fibre 507 towards Alice's receiver 503. Alice's receiver 503 comprises polarisation controller 531 which corrects for any variations in the polarisation of the photons received from cable 507. The polarisation corrected photons are then passed into a polarisation maintaining interferometer 533. Interferometer 533 comprises a short arm 535 and a long arm 537. The short arm contains a phase modulator 539 and the long arm contains a delay loop 541.

The long arm also contains an air gap 543 which can be used to vary the delay introduced in long arm 537 to balance the system. The long arm and short arm are coupled at their entrance ends by entrance coupler 545 and at their exit end by exit coupler 547. Both the entrance coupler 545 and the exit coupler 547 are 50/50 fibre couplers.

The time delay introduced by fibre loop 541 is T_{Alice}. The delay T_{Alice} should be kept equal to Tₚᵤₘₚ. This may be achieved by appropriate length of the fibre delay loop 541 and variation of the air gap 543.

The airgap 543 may be replaced by a piezo-driven fibre stretcher driven.

The phase delay between the long arm 537 and the short arm 535 of the interferometer 533 is Φ_{A}. The exit coupler 547 has two ports. The first port is connected to first polarising filter 549. The output of first polarising filter 549 is then directed to first single photon detector 551. The output from the other arm of the exit coupler 547 is directed through second polarising filter 553 and then into second single photon detector 555.

There are three arrival times for photons arriving at detectors 551 and 555.

Bob's receiver 505 is almost identical to Alice's. The only difference is that its airgap or fibre stretcher 573 allow actively tuning the phase delay by piezo-electronics.

The other photon of the entangled photon pair produced by non-linear crystal 525 is directed down optical fibre 509 towards Bob's receiver 505. Bob's receiver 505 comprises polarisation controller 561 which corrects for any variations in the polarisation of the photons received from cable 509. The polarisation corrected photons are then passed into a polarisation maintaining interferometer 563. Interferometer 563 comprises a short arm 565 and a long arm 567. The short arm contains a phase modulator 569 and the long arm contains a delay loop 571.

The long arm also contains an air gap or piezo electric fibre stretcher 573 which can be used to vary the delay introduced in long arm 567 to balance the system. The. long arm and short arm are coupled at their entrance ends by entrance coupler 575 and at their exit end by exit coupler 577. Both the entrance coupler 575 and the exit coupler 577 are 50/50 fibre couplers.

The time delay introduced by fibre loop 571 is T_{Bob}. The delay T_{Bob} should be kept equal to Tₚᵤₘₚ. This may be achieved by appropriate length of the fibre delay loop 571 and variation of the air gap 573.

The phase delay between the long arm 567 and the short arm 565 of tile interferometer 563 is Φ_{B}. The exit coupler 577 has two ports. The first port is connected to first polarising filter 579. The output of first polarising filter 579 is then directed to first single photon detector 581. The output from the other arm of the exit coupler 577 is directed through second polarising filter 583 and then into second single photon detector 585.

There are three arrival times for photons arriving at detectors 581 and 585.

There is interference for photons arriving at middle detection windows, The probability of corrected photon detection can be written as
P_{correlation}=P(Alice=A0; Bob=B0)+P(Alice=A1; Bob=B1)=0.5[1+cos(Φ_{P}+Φ_{A}+Φ_{B})]

InGaAs avalanche photodetectors A0 551, A1 555, B0 581, B1 585 operating at gated mode are used for detecting single photons. The detector is gated to be on only during the middle arrival time.

If there are two photons detected, one at Alice and one at Bob, we should expect photon clicks either at A0 and B0, or at A1 and B1 due to constructive interference when phase condition Φ_{P}+Φ_{A}φ_{B}=0 is met. Probability of photon clicks at A0 and B1 or at A1 and B0 is 0 due to destructive interference.

Prior to key distribution, the phase condition φ_{P} Φ_{A}Φ_{B}=0 should be initialised by using the piezo-driven aipgap or fibre stretcher at Bob's setup. Bob aligns the airgap or stretcher so that there is minimal coincidence count between the detectors B1 and A0.

During the key distribution, both Alice & Bob randomly modulated their phase modulators to phase delays of either 0 or 90°. Alice and Bob recorded which detector registers a photon (for example, no photon click, a photon click at 0, a photon click at 1, or one photon click at 0 and one at 1). Alice assign a click at A0 to bit=0, and at A1 to bit=1. Bob assigns a click at B0 to bit=0 and that at B1 to bit=1.

After key transfer, Alice and Bob compare phase delays they applied in each clock cycle and whether or not there is a photon click at their detectors, If they apply same phase delay in a clock cycle and they register one photon each, the measurement results will be kept. They discard measurement results for the other cases. In this way, they can form a shared binary bit sequence.

In the above set up, the entangled photon pair source 501 is a fibre based source.

It can also be based on free space optics. For example, a free space imbalanced Michelson interferometer can be used as the pump interferometer. The pumping light can be focused onto a non-linear crystal by a focusing lens, and the converted photon pairs can be collected by lens into a single mode fibre.

In the above arrangement, photon pairs are generated in the same direction, ie, collinear. They can also be generated in two different directions, as long as energy and momentum conservations are met. In this case, two separate fibre launching system can be used to collect one photon into one fibre, and the other to another single mode fibre. No further photon separation means are required in this case.

The pump interferometer 513 can also be omitted if one uses a laser source with sufficiently long coherent time. Usually the coherent time should be longer than the time it takes light pulse pass through the non-linear crystal. In this case, photon pairs can also be generated with entanglement in generation time.

1. A receiver for receiving encoded photons in a quantum communication system, the receiver comprising a decoder for decoding received encoded photons and a signal detector for detecting photons outputted from said decoder, the receiver further comprising a band pass filter configured such that said encoded photons pass through the filter before entering said signal detector.

2. A receiver according to claim 1, wherein said receiver further comprises clock receiving means for receiving a clock signal, said clock signal having a different wavelength to said encoded photons, said band pass filter being configured to block the photons from said clock signal.

3. A receiver according to claim 2, wherein said encoded photons and said clock signal are received at the same input port of the receiver, said receiver further comprising a divider to direct the encoded photons towards the decoder and the clock signal towards the clock receiving means, said band pass filter being provided after said divider in the path of the encoded photons.

4. A receiver according to any preceding claim, wherein the band pass filter has a filter width of 5 nm or less.

5. A receiver according to claim 4, wherein the band pass filter has a filter width of 1 nm or less.

6. A receiver according to any preceding claim, wherein the band pass filter is tuneable in bandpass wavelength.

7. A receiver according to any preceding claim, wherein the band pass filter comprises stack of dielectric thin films.

8. A receiver according to any preceding claim, wherein the band pass filter is integrated with optical fibres within the receiver.

9. A receiver according to any preceding claim, further comprising a polarising element configured to pass only photons of a predetermined polarisation to said detector.

10. A receiver for receiving encoded photons in a quantum communication system, the receiver comprising a decoder for decoding received encoded photons and a signal detector for detecting photons outputted from said decoder, the receiver further comprising a polarising element configured to pass only photons of a predetermined polarisation to said signal detector.

11. A receiver according to either of claims 9 or 10, wherein said polarising element is integrated with optical fibres within the receiver.

12. A receiver according to any of claims 9 to 11, wherein the polarising element is a polarising sheet or polarising beam splitter.

13. A receiver according to any preceding claim, the decoder comprising a decoding interferometer, said decoding interferometer comprises an entrance member connected to a long arm and a short arm, said long arm and said short arm being joined at their other ends by an exit member, one of said arms having a phase modulator which allows the phase of a photon passing through that arm to be set to one of at least two values.

14. A receiver according to claim 13, wherein the decoding interferometer has two outputs and said detector is connected to one of the outputs.

15. A receiver according to claim 14, further comprising a second detector connected to the other of said outputs of the decoding interferometer.

16. A quantum communication system comprising an emitter and a receiver, said emitter comprising an encoder, a signal source and a clock signal source, said photon source outputting photons to said encoder for encoding, the receiver being a receiver in accordance with any claims 1 to 15.

17. A quantum communication system according to claim 16, wherein said photon signal source is tuneable in wavelength.

18. A quantum communication system according to either of claims 16 or 17, wherein said encoder comprises an encoding interferometer said encoding interferometer comprising an entrance member connected to a long arm and a short arm, said long arm and said short arm being joined at their other ends by an exit member, one of said arms having a phase modulator which allows the phase of a photon passing through that arm to be set to one of at least two values.

19. A quantum communication system according to any of claims 16 to 18, wherein the clock source emits at a wavelength of substantially 1.3 μm and the source for the encoded photons emits at a wavelength of substantially 1.55 μm.

20. A quantum communication system according to any of claims 16 to 18, comprising an optical fibre configured to transmit encoded photons and the clock signal from the emitter to the receiver, the fibre having a length of at least 50 m.

21. A quantum communication system comprising an entangled photon emitter and two receivers, each receiver being a receiver according to any of claims 1 to 15, said entangled photon emitter comprising a source which is configured to emit photons which are entangled in phase, polarisation or energy/tine.

22. A quantum communication system comprising a first station and a second station, said first station comprising a receiver in accordance with any of claims 1 to 15 and a photon source configured to output a photon pulse through the decoder of said first station, said second station comprising means to apply an encoding signal to said photons and reflecting means to reflect the pulse back through the decoder of said first station.

23. A method of receiving encoded photons in a quantum communication system, the method comprising:
filtering the encoded photons using a band pass filter configured to pass encoded photons;
passing the encoded photons through a decoder; and
detecting the photons outputted by the decoder.

24. A method of receiving encoded photons in a quantum communication system, the method comprising:
passing the encoded photons through a decoder;
passing the encoded photons through a polarisation element; and
detecting the polarisation filtered encoded photons,
wherein said polarisation element is configured to only pass photons of a predetermined polarisation for detection.

25. A method of quantum communication comprising:
producing encoded photons in an emitter;
sending the encoded photons from the emitter to a receiver;
filtering the encoded photons at the receiver using a band pass filter configured to pass encoded photons;
passing the encoded photons through a decoder, and
detecting the photons outputted by the decoder.

26. A method of quantum communication comprising:
producing encoded photons in an emitter;
sending the encoded photons from the emitter to a receiver;
passing the encoded photons through a decoder at the receiver;
passing the decoded photons through a polarisation element; and
detecting the polarisation filtered encoded photons,
wherein said polarisation element is configured to only pass photons of a pre-determined polarisation for detection.
